(19) United States
(12) Patent Application Publication
(10) Pub. No.: US 2024/0401868 A1
(43) Pub. Date: Dec. 5, 2024

(54) NETWORK SYSTEM AND INFORMATION PROCESSING METHOD

(71) Applicant: SHARP KABUSHIKI KAISHA, Sakai City (JP)

(72) Inventor: HISASHI IDE, Sakai City (JP)

(21) Appl. No.: 18/679,074

(22) Filed: May 30, 2024

(30) Foreign Application Priority Data
Jun. 1, 2023 (JP) 2023-090646

(51) Int. Cl. F25D 23/00; G01D 9/00

(52) U.S. Cl. CPC F25D 23/003; G01D 9/007; F25D 2600/02

(57) ABSTRACT

Provided is a network system including a communication terminal to be used by a user and a server configured to communicate with the communication terminal. The communication terminal accepts input of a product to be purchased. The server deletes the input product to be purchased from stock in a refrigerator corresponding to the user. Upon accepting purchased product information from a mobile terminal device or the like, the server adds the information to the stock in the refrigerator.

### CROSS-REFERENCE TO RELATED APPLICATIONS

This application claims the benefit of priority to Japanese Patent Application Number 2023-090646 filed on Jun. 1, 2023. The entire contents of the above-identified application are hereby incorporated by reference.

### BACKGROUND

### Technical Field

The disclosure relates to a technique for grasping stock in a refrigerator.

A technique for grasping foodstuffs stored in a refrigerator has been known. For example, JP 2005-202696 A discloses a refrigerator stock food management system, a refrigerator, and a recipe server. According to JP 2005-202696A, the refrigerator stock food management system includes a refrigerator including a food stock cooking information management device and a mobile terminal device that transmits a stock information acquisition request for requesting acquisition of stock information. The food stock cooking information management device acquires food information indicating the name and quantity of food stored in or taken out from the refrigerator to manage stock information of the food stored in the refrigerator, searches for, upon accepting the stock information acquisition request from the mobile terminal device, information on cooking that can be cooked based on the stock information related to the stock information acquisition request for the mobile terminal device, and transmits the information to the mobile terminal device.

### SUMMARY

An object of the disclosure is to provide a system for efficiently grasping stock in a refrigerator with a simple configuration.

According to an aspect of the disclosure, provided is a network system including a communication terminal to be used by a user and a server configured to communicate with the communication terminal. The communication terminal accepts input of a product to be purchased. The server deletes the input product to be purchased from stock in a refrigerator corresponding to the user. Upon accepting purchased product information from a mobile terminal device or the like, the server adds the information to the stock in the refrigerator.

As described above, the disclosure provides a system for efficiently grasping stock in a refrigerator with a simple configuration.

### BRIEF DESCRIPTION OF DRAWINGS

The disclosure will be described with reference to the accompanying drawings, wherein like numbers reference like elements.

FIG. 1 is a conceptual diagram illustrating an overall configuration of a network system 1 according to a first embodiment.

FIG. 2 is a conceptual diagram illustrating an overview of an operation of the network system 1 according to the first embodiment.

FIG. 3 is a block diagram illustrating a configuration of a server 100 according to the first embodiment.

FIG. 4 is a conceptual diagram illustrating user information data 121 according to the first embodiment.

FIG. 5 is a conceptual diagram illustrating device information data 122 according to the first embodiment.

FIG. 6 is a conceptual diagram illustrating stock information data 123 according to the first embodiment.

FIG. 7 is a conceptual diagram illustrating shopping memo data 124 according to the first embodiment.

FIG. 8 is a conceptual diagram illustrating period information data 125 according to the first embodiment.

FIG. 9 is a conceptual diagram illustrating menu information data 126 according to the first embodiment.

FIG. 10 is a flowchart illustrating information processing for adding a product to be purchased, in the server 100 according to the first embodiment.

FIG. 11 is a flowchart illustrating information processing executed when a product is purchased, in the server 100 according to the first embodiment.

FIG. 12 is a block diagram illustrating a configuration of a refrigerator 200 according to the first embodiment.

FIG. 13 is a conceptual diagram illustrating an overview of an operation performed when a shopping memo is input by voice to the refrigerator 200 according to the first embodiment.

FIG. 14 is a block diagram illustrating a configuration of a communication terminal 300 according to the first embodiment.

FIG. 15 is a flowchart illustrating information processing executed when a product is purchased, in the server 100 according to a second embodiment.

FIG. 16 is a flowchart illustrating information processing executed when a product to be purchased is automatically added, due to expiration, according to a fourth embodiment.

### DESCRIPTION OF EMBODIMENTS

Embodiments of the disclosure will be described below with reference to the drawings. In the following description, the same components will be denoted by the same reference numerals and signs. The names and functions of the components are also the same. Thus, detailed descriptions thereof will not be repeated.

### First Embodiment

### Overview of Network System 1

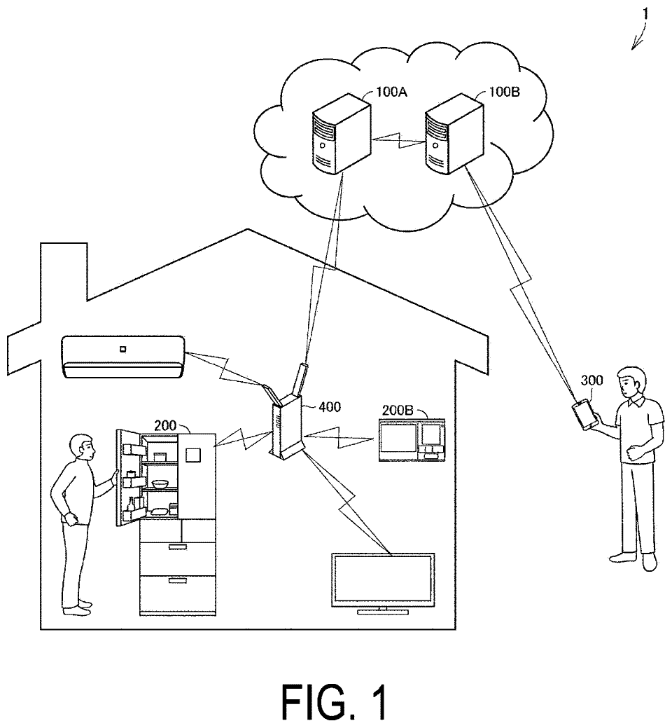

First, with reference to FIG. 1, an overall configuration of a network system 1 according to the present embodiment will be described. The network system 1 according to the present embodiment mainly includes a server 100, home appliances such as a refrigerator 200 and a microwave oven 200B, a communication terminal 300 such as a smartphone and a tablet, a wireless router 400 for connecting the refrigerator 200, the microwave oven 200B, and the like to an external network such as the Internet, and the like.

In the present embodiment, examples of the server 100 prepared include a home appliance server 100A that mainly exchanges data with the refrigerator 200 and an SNS server 100B that provides Social Networking Service (SNS). Hereinafter, these servers are also collectively referred to as the server 100.

The communication terminal 300 is not limited to the smartphone, and may be a personal computer, a tablet, a gaming machine, a speaker, a wearable terminal, or the like. Hereinafter, these communication terminals are also collectively referred to as the communication terminal 300.

### Functional Configuration of Network System 1

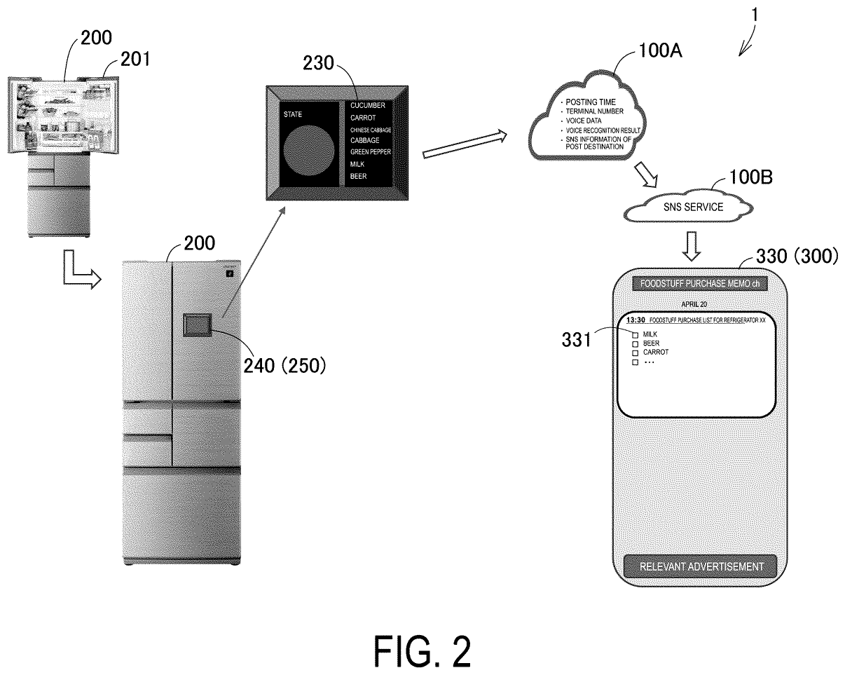

Now, with reference to FIGS. 1 and 2, an overview of an operation of the network system 1 according to the present embodiment will be described. In the following description, an overview of an operation for managing the stock of foodstuffs stored in the refrigerator 200 will be described. However, the stock management target is not limited to foodstuffs and may be “products” in general. It should be noted that the “product” includes a foodstuff before processing, a foodstuff or a product after processing or cooking, a seasoning, a beverage, and the like. Furthermore, the product is not limited to food and drink, and further includes general daily necessities and the like.

First, while pressing an input button of the refrigerator 200, the user inputs by voice, a foodstuff he or she wants to purchase. As a result, the server 100 recognizes that the foodstuff is not stocked in the refrigerator 200, and adds the foodstuff to a list of shopping memo corresponding to the user. In the present embodiment, the server 100 will thereafter present a menu that does not require the foodstuff to the user.

Then, when the user or a family member of the user goes to a supermarket for shopping or in the other like cases, the user or the family member accesses a family channel of the SNS using the communication terminal 300 such as a smartphone to check the list of shopping memo. This list can be managed together with a check box 331, and the user or the family member of the user checks the check box of the list of shopping memo related to the purchased foodstuff. Thus, the server 100 recognizes that the refrigerator 200 has been replenished with the foodstuff, and deletes the foodstuff from the shopping list corresponding to the user. In the present embodiment, the server 100 will thereafter present a menu that does require the foodstuff to the user.

As described above, the network system 1 according to the present embodiment can grasp or predict foodstuffs stored in the refrigerator with a simple configuration and simple information processing. Hereinafter, a specific configuration of the network system 1 for achieving such a function will be described in detail.

### Configuration of Server

First, an aspect of a configuration of the server 100 configuring the network system 1 according to the present embodiment will be described. The functions used in the network system 1 according to the present embodiment are not limited to those being achieved by the two servers 100 such as the home appliance server 100A and the SNS server 100B, and the number of devices on the cloud realizing the functions can be larger or smaller. Hereinafter, for the sake of description, the description is given with a group of these servers regarded as one server 100.

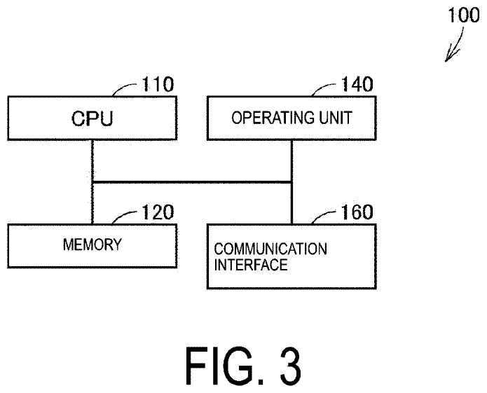

As illustrated in FIG. 3, the server 100 includes a central processing unit (CPU) 110, a memory 120, an operating unit 140, and a communication interface 160 as main components.

The CPU 110 controls each unit of the server 100 by executing programs stored in the memory 120. For example, the CPU 110 performs various types of processing, which will be described below, by executing programs stored in the memory 120 and referring to various types of data.

The memory 120 may be implemented by various types of random access memory (RAM), various types of read-only memory (ROM), and the like. The memory 120 may be embedded in the server 100, may be removably attached to various interfaces of the server 100, or may be a recording medium of another device accessible from the server 100. The memory 120 stores the programs that are executed by the CPU 110, data generated as a result of the CPU 110 executing the programs, input data, other databases used for services relating to the present embodiment, and the like.

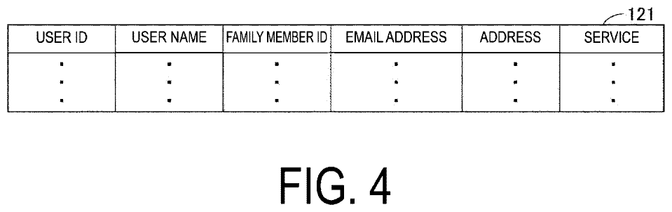

For example, the memory 120 stores user information data 121, as illustrated in FIG. 4. The user information data 121 stores, for each user registered for the service, a user ID, a user name, a family member ID, an email address, an address, identification information regarding various services to which a user is subscribed, the contents of the services, and the like.

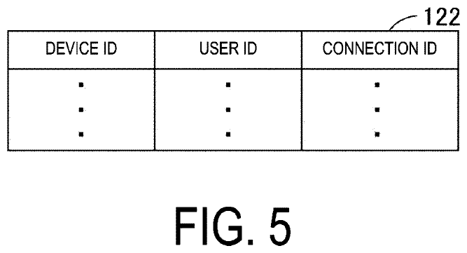

The memory 120 stores device information data 122 as illustrated in FIG. 5. The device information data 122 stores, for each refrigerator registered for the service, a device ID, a user ID of the refrigerator, a connection ID for pairing, and the like.

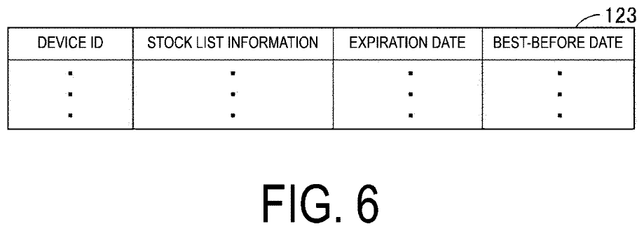

The memory 120 stores stock information data 123, as illustrated in FIG. 6. The stock information data 123 stores, for each refrigerator registered for the service, a device ID, a list of foodstuffs stored in the refrigerator, and an expiration date and a best-before date for each foodstuff.

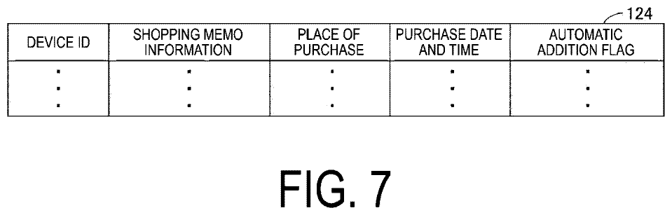

The memory 120 stores shopping memo data 124 as illustrated in FIG. 7. The shopping memo data 124 stores, for each refrigerator registered for the service, a device ID, a list of products to be purchased, a flag indicating whether the product has been purchased, a place of purchase, a purchase date and time, and a flag indicating that the product has been automatically added by the system.

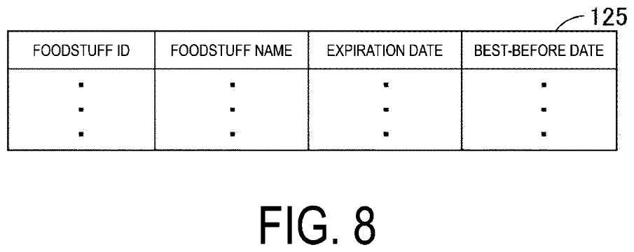

The memory 120 stores period information data 125 as illustrated in FIG. 8. The period information data 125 stores for each foodstuff or product registered for the service, the name, a standard period until the expiration date, and a standard period until the best-before date.

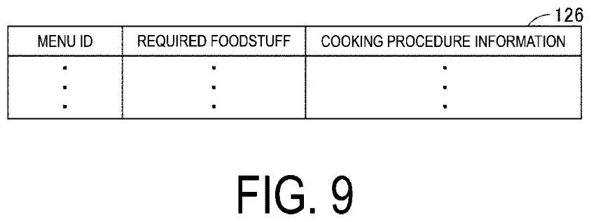

The memory 120 stores menu information data 126 as illustrated in FIG. 9. The menu information data 126 stores for each menu registered for the service, a menu ID, necessary ingredients, cooking menus, and the like.

Furthermore, the memory 120 stores an ID of a user such as a family member registered in the channel of the SNS, a posting history for each channel, voice data received from the refrigerator 200, text data converted from the voice, and other various types of data used for the service according to the present embodiment. In the present embodiment, it is assumed that an SNS channel is prepared for each family member, and keywords corresponding to candidates related to foodstuffs and products are prepared.

With reference to FIG. 3 again, the operating unit 140 accepts a command from a service administrator or the like, and inputs the command to the CPU 110.

The communication interface 160 transmits data from the CPU 110 to the other apparatuses such as the refrigerator 200 and the communication terminal 300 via the Internet, a carrier network, a router, or the like. On the other hand, the communication interface 160 receives data from the other apparatuses such as the refrigerator 200 and the communication terminal 300 via the Internet, the carrier network, the router, or the like and transfers the data to the CPU 110.

### Information Processing in Network System

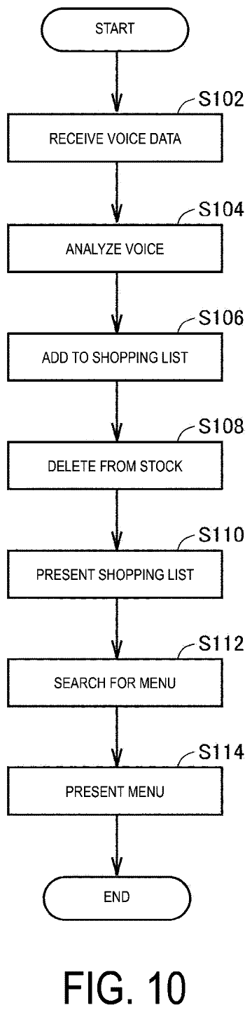

Next, information processing for adding a foodstuff to the shopping memo in the server 100 according to the present embodiment will be described with reference to FIG. 10. The CPU 110 of the server 100 executes the following processing in accordance with the program in the memory 120.

The CPU 110 receives voice data from the refrigerator 200 via the communication interface 160 (step S102).

The CPU 110 analyzes the voice data and recognizes the names of a foodstuff and another product (step S104).

The CPU 110 adds the foodstuff or the product to the list of the shopping memo data 124 corresponding to the relevant refrigerator 200 (step S106).

The CPU 110 deletes the foodstuff or the product from the list of the stock information data 123 corresponding to the relevant refrigerator 200 (step S108).

Accordingly, when a user or a family member of the user belonging to the SNS channel of the family member of the user corresponding to the refrigerator 200 accesses the page of the channel via his/her communication terminal 300, the CPU 110 of the server 100 can cause the communication terminal 300 to display a list of foodstuffs and products via the communication interface 160 (step S110).

Furthermore, when the user or a family member of the user corresponding to the refrigerator 200 requests for a recommended menu using his/her communication terminal 300, the CPU 110 of the server 100 can search for a menu based on the list of the latest stock information data 123 corresponding to the refrigerator 200, that is, a menu that does not require the newly added foodstuff (step S112), and transmit information such as ingredients and cooking menus related to the menu to the communication terminal 300 via the communication interface 160 for display (step S114).

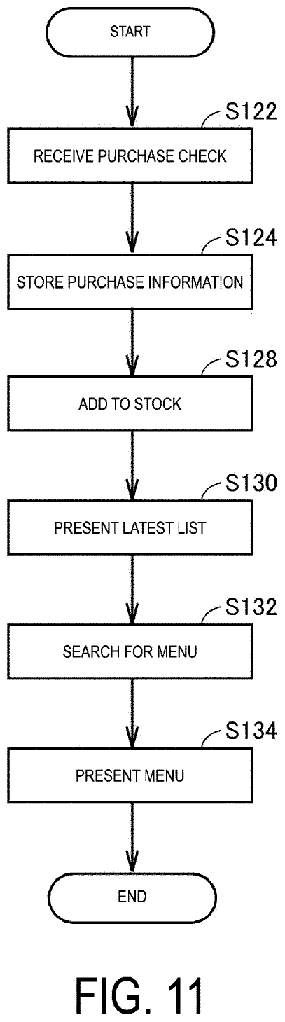

Next, information processing executed when the purchased foodstuff is deleted from the shopping memo in the server 100 according to the present embodiment will be described with reference to FIG. 11. The CPU 110 of the server 100 executes the following processing in accordance with the program in the memory 120.

The CPU 110 acquires, from the communication terminal 300 via the communication interface 160, information indicating that the foodstuff and the product in the shopping list have been checked (step S122). It is assumed that the user accesses the page of the channel at the time of shopping and performs shopping with reference to the shopping memo. It is recognized that the user has purchased a product at the timing when the check box 331 is checked. In the present embodiment, the CPU 110 also receives the current position information from the communication terminal 300 (step S122).

The CPU 110 checks the foodstuff and the product in the shopping list of the shopping memo data 124 related to the refrigerator 200 corresponding to the user of the communication terminal 300, stores the purchase date and time, and stores the place of purchase (step S124).

The CPU 110 adds the foodstuff or the product to the list of the stock information data 123 corresponding to the relevant refrigerator 200 (step S128).

Accordingly, when a user or a family member of the user belonging to the SNS channel of the family member of the user corresponding to the refrigerator 200 accesses the page of the channel via his/her communication terminal 300, the CPU 110 of the server 100 can cause the communication terminal 300 to display the latest list of foodstuffs and products via the communication interface 160 (step S130).

Furthermore, when the user or a family member of the user corresponding to the refrigerator 200 requests for a recommended menu using his/her communication terminal 300, the CPU 110 of the server 100 can search for a menu based on the list of the latest stock information data 123 corresponding to the refrigerator 200, that is, a menu that requires the newly purchased foodstuff (step S132), and transmit information related to the menu to the communication terminal 300 via the communication interface 160 for display (step S134). Configuration of Refrigerator 200

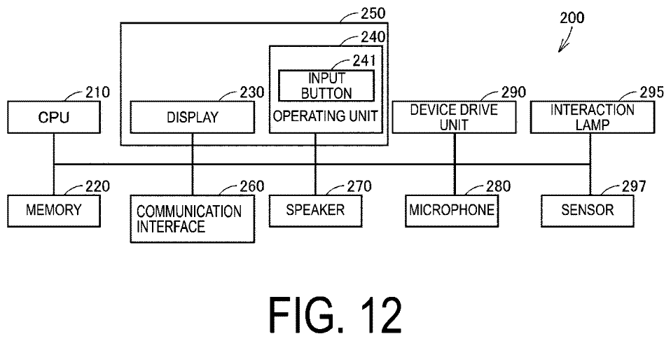

Now, with reference to FIG. 12, an aspect of a configuration of the refrigerator 200 included in the network system 1 will be described. The refrigerator 200 according to the present embodiment includes a CPU 210, a memory 220, a display 230, an operating unit 240, a communication interface 260, a speaker 270, a microphone 280, a device drive unit 290, a lamp 295, various sensors 297, and the like as main components.

The CPU 210 executes programs stored in the memory 220 or an external storage medium to control units of the refrigerator 200.

The memory 220 is implemented by various RAMs, various ROMs, and the like, stores programs executed by the CPU 210, data generated by executing the programs by the CPU 210, data input via the operating unit 240, voice data input via the microphone 280, data received from a remote controller, data received from the server 100 via a router 400 and the Internet, information necessary to utilize various services, such as a management server address corresponding to the refrigerator 200, and the like.

The display 230 outputs characters, images, and the like based on signals from the CPU 210.

The operating unit 240 is implemented by a button, a touch panel, and the like, accepts commands from the user, and inputs the commands to the CPU 210. In particular, in the present embodiment, the operating unit 240 includes an input button 241 for inputting voice. The display 230 and the operating unit 240 may constitute a touch panel 250.

The communication interface 260 is implemented by an antenna for performing wireless communications, a connector for performing wired communications, and the like. The CPU 210 utilizes the communication interface 260 to exchange various types of data with the server 100, another refrigerator 200, the communication terminal 300, or the like via the router 400, the Internet, and the like. For example, the CPU 210 transmits the operation content, environment information, user voice data, and the like to the server 100, and receives an operation command, voice data, and the like from the server 100, via the communication interface 260.

The speaker 270 outputs voice messages and the like based on voice data from the CPU 210. The microphone 280 acquires the voice of the user and the like and inputs the voice data to the CPU 210. In particular, in the present embodiment, the CPU 210 transmits voice data accepted from the microphone 280 to the server 100 via the communication interface 260, and outputs a voice message received from the server 100, through the speaker 270.

The device drive unit 290 controls each unit (such as a motor, a heater, a sensor, an antenna, or the like) of the refrigerator 200 based on signals from the CPU 210. The device drive unit 290 is, for example, a compressor or a fan in a case of a refrigerator or an air conditioner, an antenna or a rotary table for heat cooking in a case of a microwave oven, or a reception antenna or a tuner in a case of a television.

The lamp 295 is a lamp that emits light indicating that voice interaction or user voice recording (acquisition) is in progress, in accordance with an instruction from the CPU 210.

For example, the various sensors 297 include an opening/closing sensor for a door 201, detecting opening/closing of the door 201, and inputting the detection result to the CPU 210. Alternatively, the various sensors 297 include an accelerometer that detects vibrations and input the detection result to the CPU 210. The various sensors 297 may include a human sensor or the like.

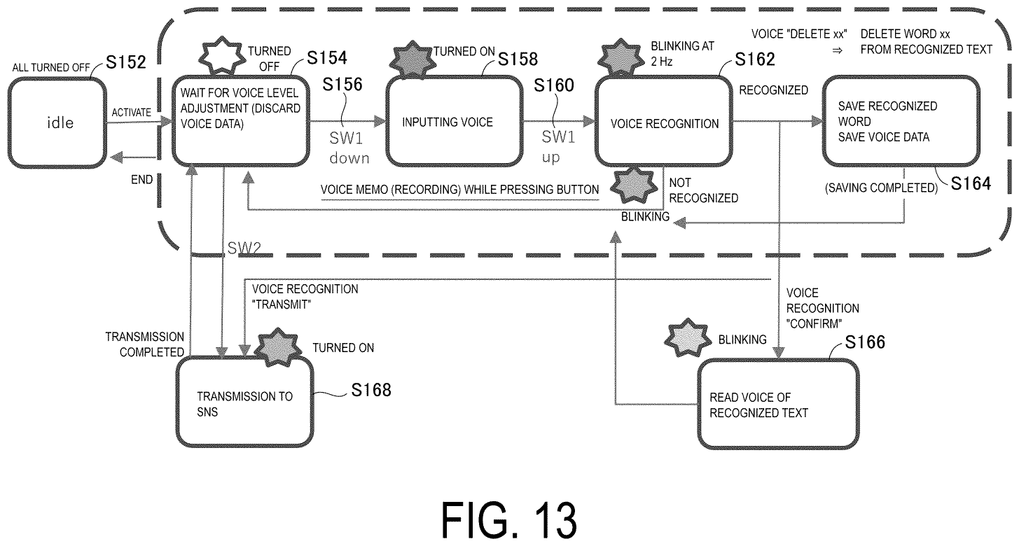

In the present embodiment, as illustrated in FIG. 13, the CPU 210 activates the microphone 280 and accepts input of voice while the input button 241 of the operating unit 240 is pressed.

More specifically, a display 230 of refrigerator 200 is normally turned off (step S152).

When the user touches the touch panel 250 or the door 201 is opened, the CPU 210 activates the display 230 (step S154). At this time, the interaction lamp 295 is turned off.

When the input button 241 is pressed (step S156), the CPU 210 activates the microphone 280 and accepts input of an utterance of the user (step S158). Until the input button 241 is turned off, the CPU 210 activates the microphone 280 and accepts input of the utterance of the user.

When the user removes his/her finger from the input button 241 (step S160), the CPU 210 stops the recording and performs voice analysis by transmitting the voice data to the server 100 via the communication interface 260 (step S162).

The list of the recognized names of the foodstuffs and products is temporarily held in the memory 220 (step 164), and the CPU 210 can output the content of the list on the display 230 for display confirmation. Furthermore, a keyword (“confirm” in this example) may be input by voice, and the CPU 210 may implement the confirmation through voice reading through the speaker 270 (step S166).

When the voice analysis result notified in step S164 includes a keyword for deletion (“delete” in this example), part of the list of names of foodstuffs and products temporarily held in the memory 220 can be edited through deletion (step S164). For example, when the user utters “delete”, the foodstuff that is most recently added to the shopping memo is deleted. When the user utters “foodstuff 1 (such as, for example, green onion or milk), delete”, the designated foodstuff is deleted from the shopping memo.

The user can store a list of a plurality of foodstuffs and products in the memory 220 by repeating the processing from step S156 for foodstuffs and products to be purchased. By voice-inputting a keyword for transmission (“transmit” in this example) to the server 100 in this state, the CPU 210 transmits shopping list data. The data is added to the shopping list in the server 100 or uploaded to the shopping list of the SNS (step S168). The CPU 210 may issue an instruction for the transmission of the shopping list data, at a timing when the user presses another button on the operating unit 240.

### Configuration of Communication Terminal 300

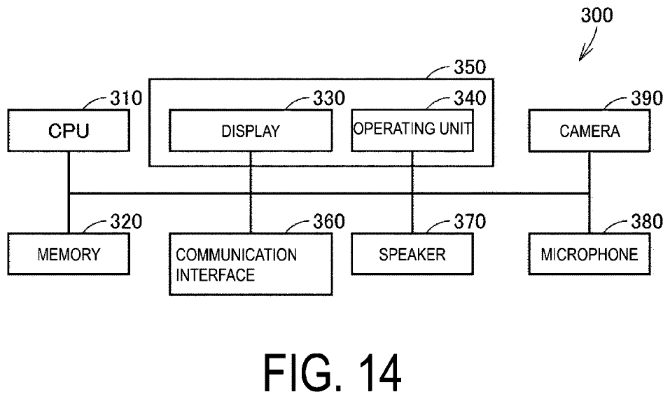

Now, with reference to FIG. 14, an aspect of a configuration of the communication terminal 300 included in the network system 1 will be described. The communication terminal 300 according to the present embodiment includes a CPU 310, a memory 320, a display 330, an operating unit 340, a communication interface 360, a speaker 370, a microphone 380, a camera 390, and the like as main components.

The CPU 310 controls each unit of the communication terminal 300 by executing a program stored in the memory 320.

The memory 320 is implemented by various types of RAM, various types of ROM, and the like. The memory 320 stores application programs for various services, an application program for a notification agent, data generated by the CPU 310 executing the programs, data received from the server 100, data input via the operating unit 340, information used to identify the user of the communication terminal 300, and the like.

The display 330 displays images and text based on the data from the CPU 310. The operating unit 340 includes a pointing device, a switch, and the like, and allows various types of commands from the user to be input into the CPU 310. A user terminal may include a touch panel 350 including the display 330 and the operating unit 340.

The communication interface 360 transmits and/or receives data to and/or from other apparatuses such as the server 100 and the refrigerator 200, via the Internet, the carrier network, the router 400, or the like. For example, the CPU 310 exchanges various types of information related to the user with the server 100 via the communication interface 360 in accordance with the program. The CPU 310 can receive various services by providing the various types of information to other application programs.

The speaker 370 outputs various voice messages or the like, based on voice data from the CPU 310. The microphone 380 acquires the voice of the user and the like and inputs the voice data to the CPU 310. The camera 390 captures a still image or a moving image, inputs the image to the CPU 310, and stores the image in the memory 320.

With such a configuration, the CPU 310 requests the server 100 for posted data on a desired channel of the SNS via the communication interface 360 based on the user instruction, displays the shopping list and the check box on the display 330 as a page of the channel of a family member of the user based on information from the server 100, or accepts input for checking of a purchased foodstuff or product using the operating unit 340 or the microphone 380.

### Second Embodiment

In the above-described embodiment, when the check box displayed next to the foodstuff in the shopping list is checked (step S122), the foodstuff is added as stock in the refrigerator 200 (step S128). Alternatively, the CPU 110 of the server 100 may add the foodstuff as the stock in the refrigerator 200 when a predetermined period of time, for example, two hours or the like, elapses after the check box of the foodstuff of the shopping list has been checked (step S122).

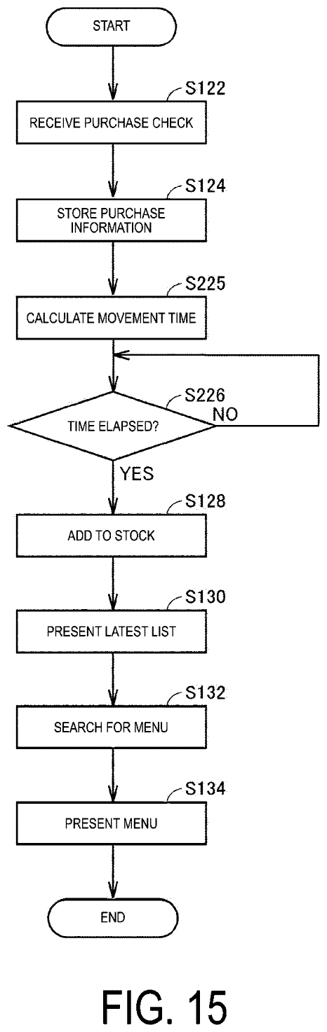

More preferably, referring to FIG. 15, the CPU 110 acquires, from the communication terminal 300 via the communication interface 160, information indicating that a foodstuff or product in the shopping list has been checked (step S122). In the present embodiment, the CPU 110 also receives the current position information from the communication terminal 300 (step S122).

The CPU 110 checks the foodstuff and the product in the shopping list of the shopping memo data 124 related to the refrigerator 200 corresponding to the user of the communication terminal 300, stores the purchase date and time, and stores the place of purchase (step S124).

The CPU 110 calculates the time it takes to move from the place of purchase to the user's address (step S225). After the time has elapsed (YES in step S226), the CPU 110 adds the foodstuff or the product to the list of the stock information data 123 corresponding to the relevant refrigerator 200 (step S128).

### Third Embodiment

Furthermore, it is also preferable that the stock in the refrigerator 200 can be directly registered in the server 100 manually or by voice, via the operating unit 240 of the refrigerator 200 or using the communication terminal 300. For example, the CPU 210 of the refrigerator 200 may directly accept input of a foodstuff not included in the shopping list, a best—before date, or the like via the operating unit 240 according to an application program for stock management. Specifically, the user utters the foodstuff name while pressing the input button 241 of the operating unit 240. The CPU 210 acquires the voice through the microphone 280, and transmits the voice information to the server 100 via the communication interface 260. As a result, the CPU 110 of the server 100 adds the foodstuff or product identified by analyzing the voice to the list of the stock information data 123 corresponding to the relevant refrigerator 200.

In such an embodiment, when the same foodstuff is directly added to the shopping list within several hours and the check box of the shopping list is checked, the CPU 110 of the server 100 preferably registers only one of the directly registered foodstuff and the checked foodstuff in the stock information data 123. Thus, it is possible to prevent one purchased product from being registered as two pieces of stock. Alternatively, it is possible to prevent information on two purchases from being accumulated even though the purchase is made only once.

More specifically, referring to FIG. 15, the CPU 110 calculates the time it takes to move from the place of purchase to the user's address (step S225). After the relevant time plus about one hour has elapsed (YES in step S226), the CPU 110 adds the foodstuff or the product to the list of the stock information data 123 corresponding to the relevant refrigerator 200 (step S128). Then, in a case where the same foodstuff or product is directly registered as the stock in the refrigerator 200 within several hours before and after the time, the CPU 110 of the server 100 does not directly register the foodstuff as the stock. Alternatively, the checked foodstuff is not registered as the stock.

This makes it possible to search for a recipe that allows the one who went shopping, brought back the foodstuff to his or her home, and put it in the refrigerator 200, to search for a recipe that can be cooked. Furthermore, as described above, it is also possible to prevent one purchased product from being registered as two pieces of stock.

### Fourth Embodiment

In addition to the above-described embodiment, when the expiration date or the best-before date of the foodstuff contained as the stock in the refrigerator 200 is reached, the foodstuff may be automatically deleted from the stock information data 123 and added to the shopping memo data 124. However, in order to prevent the user from being confused, when the shopping list is displayed, it is preferable to add a predetermined icon, an image, or a description.

More specifically, the CPU 110 of the server 100 executes the following processing in accordance with the program in the memory 120 periodically, that is, once in every 12 hours for example.

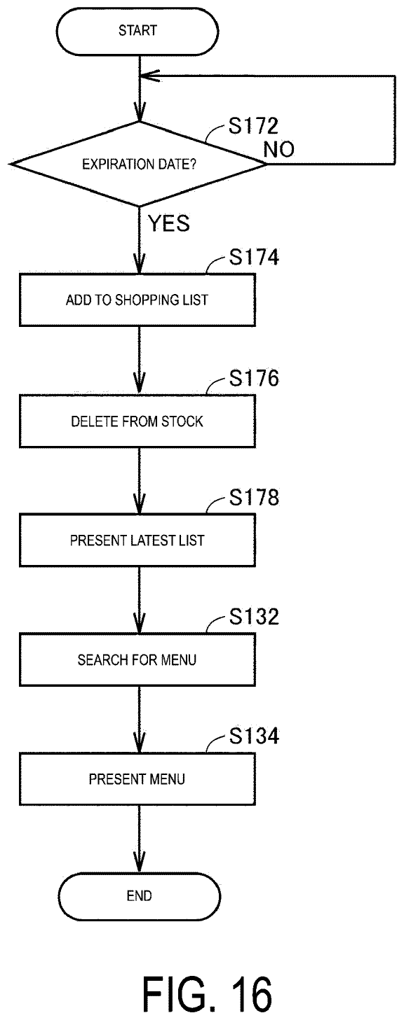

Referring to FIG. 16, the CPU 110 of server 100 refers to the stock information data 123 to determine whether there is a foodstuff whose expiration date has been reached (step S172). When there is a foodstuff whose expiration date has been reached (YES in step S172), the CPU 110 adds the foodstuff to the list of shopping memo data 124 corresponding to the relevant refrigerator 200 (step S174). At this time, the CPU 110 adds information indicating the automatic addition to the list.

The CPU 110 deletes the foodstuff from the list of the stock information data 123 corresponding to the relevant refrigerator 200 (step S176).

Accordingly, when a user or a family member of the user belonging to the SNS channel of the family member of the user corresponding to the refrigerator 200 accesses the page of the channel via his/her communication terminal 300, the CPU 110 of the server 100 can cause the communication terminal 300 to display the list of foodstuffs and products including the automatically added one(s) via the communication interface 160 (step S178). At this time, the CPU 110 causes the communication terminal 300 to display a list of the foodstuffs together with an icon indicating the automatic addition.

Furthermore, when the user or a family member of the user corresponding to the refrigerator 200 requests for a recommended menu using his/her communication terminal 300, the CPU 110 of the server 100 can search for a menu based on the list of the latest stock information data 123 corresponding to the refrigerator 200, that is, a menu not requiring the foodstuff deleted due to expiration (step S132), and transmit information related to the menu to the communication terminal 300 via the communication interface 160 for display (step S134).

In step S172, the CPU 110 may determine whether there is a foodstuff whose best-before date has been reached.

Alternatively, in step S172, the CPU 110 may determine whether there is a foodstuff whose expiration date will be reached in a predetermined period of time, such as only 24 hours for example. Alternatively, in step S172, the CPU 110 may determine whether there is a foodstuff whose best-before date will be reached in a predetermined period of time, such as only 24 hours for example.

In this case, it is preferable that the CPU 110 does not delete from the stock in the refrigerator 200 until the expiration date is reached, but rather makes the menu requiring the foodstuff preferentially displayed at a higher position.

### Fifth Embodiment

In the above-described embodiment, the refrigerator 200 acquires the voice of the user using the microphone 280. However, the disclosure is not limited to such an embodiment. For example, a communication adapter attached to the refrigerator 200 using magnets, the microwave oven 200B, or the communication terminal 300 such as a smartphone may partially or entirely achieve the functions of the refrigerator 200. The configurations of the communication adapter and the microwave oven 200B are the same as the configuration illustrated in FIG. 12 except for the configuration of the device drive unit 290, and the operation of the CPU 210 is also the same, so that description thereof will not be repeated here.

Alternatively, some or all of the roles of each of the servers 100 in the above-described embodiment may be performed by other devices. For example, the refrigerator 200 itself may recognize the voice, and store or update the stock information data 123 and the shopping memo data 124.

### Supplement

In the above-described embodiment, provided is a network system including a communication terminal to be used by a user and a server configured to communicate with the communication terminal. The communication terminal accepts input of a product to be purchased. The server deletes the input product to be purchased from stock in a refrigerator corresponding to the user.

Preferably, the communication terminal is implemented by at least any of a refrigerator, a communication adapter, and a mobile terminal. The communication terminal accepts input of a voice for designating a product to be purchased via a microphone while a predetermined button is being pressed. In response to the input, the server deletes the product from the stock in the refrigerator.

Preferably, the server stores an expiration date or a best-before date for each product. The server automatically adds, as a product to be purchased, a product almost having the expiration date or the best-before date with specific identification information attached.

Preferably, the server presents a menu that does not include the product to be purchased to the user.

In the above-described embodiment, provided is a network system including a communication terminal to be used by a user and a server configured to communicate with the communication terminal. The communication terminal displays a list of products to be purchased and accepts a command to designate a purchased product from the user. The server adds the purchased product to the stock in the refrigerator corresponding to the user.

Preferably, the communication terminal is implemented by at least any of a refrigerator, a communication adapter, and a mobile terminal. The communication terminal accepts input of a voice for designating a product stored in the refrigerator via a microphone while a predetermined button is being pressed. The server adds the product to the stock in the refrigerator in response to the input.

Preferably, the server presents a menu including the product added to the stock in the refrigerator to the user.

In the above-described embodiment, provided is an information processing method including the steps of accepting, by a communication terminal, input of a product to be purchased from a user and deleting, by a server, the input product to be purchased from stock in a refrigerator corresponding to the user.

In the above-described embodiment, provided is an information processing method including the steps of displaying, by a communication terminal, a list of products to be purchased, accepting, by the communication terminal, a command to designate a purchased product from a user, and adding, by a server, the purchased product to stock in a refrigerator corresponding to the user in accordance with information from the communication terminal.

All aspects of the embodiments disclosed herein are to be understood as being illustrative and not restrictive. The scope of the disclosure is defined not by the foregoing descriptions but by the appended claims and is intended to include all changes equivalent in meaning and scope to the claims.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A network system, comprising:
a communication terminal to be used by a user; and
a server configured to communicate with the communication terminal, wherein
the communication terminal accepts input of a product to be purchased, and
the server deletes, from stock in a refrigerator corresponding to the user, the product to be purchased input.

2. The network system according to claim 1, wherein
the communication terminal is implemented by at least any of a refrigerator, a communication adapter, and a mobile terminal,
the communication terminal accepts input of a voice for designating the product to be purchased via a microphone while a predetermined button is being pressed, and
the server deletes the product from the stock in the refrigerator in response to the input.

3. The network system according to claim 1, wherein the server stores an expiration date or a best-before date for each product and automatically adds, as the product to be purchased, a product almost having the expiration date or the best-before date with predetermined identification information added.

4. The network system according to claim 1, wherein the server presents a menu that does not include the product to be purchased to the user.

5. A network system, comprising:
a communication terminal to be used by a user; and
a server configured to communicate with the communication terminal, wherein
the communication terminal displays a list of products to be purchased and accepts a command designating a purchased product from the user, and
the server adds the purchased product to stock in a refrigerator corresponding to the user.

6. The network system according to claim 5, wherein
the communication terminal is implemented by at least any of a refrigerator, a communication adapter, and a mobile terminal;
the communication terminal accepts input of a voice for designating a product stored in the refrigerator via a microphone while a predetermined button is being pressed, and
the server adds the product to the stock in the refrigerator in response to the input.

7. The network system according to claim 5, wherein the server presents a menu including the product added to the stock in the refrigerator to the user.

8. An information processing method, comprising:
accepting, by a communication terminal, input of a product to be purchased from a user; and
deleting, by a server, from stock in a refrigerator corresponding to the user, the product to be purchased input in accordance with information from the communication terminal.

9. The information processing method according to claim 8, the information processing method further comprising:
displaying, by the communication terminal, a list of products to be purchased;
accepting, by the communication terminal, a command designating a purchased product from the user; and
adding, by the server, the purchased product to stock in the refrigerator corresponding to the user in accordance with information from the communication terminal.
